(19) United States
(12) Patent Application Publication
(10) Pub. No.: US 2004/0039192 A1
(43) Pub. Date: Feb. 26, 2004

(54) Recovery of oxygen linked oligosaccharides from mammal glycoproteins

(76) Inventors: Nicolle Hannah Packer, New South Wales (AU); Niclas Karlsson, New South Wales (AU)

Correspondence Address: KNOBBE MARTENS OLSON & BEAR LLP, 2040 MAIN STREET, FOURTEENTH FLOOR, IRVINE, CA, 92614, US

(21) Appl. No.: 10/333,541

(22) PCT Filed: Jul. 18, 2001
(86) PCT No.: PCT/AU01/00871

(30) Foreign Application Priority Data
Jul. 18, 2000 (AU) PQ 8854

(51) Int. Cl. C08B 37/00

(52) U.S. Cl. 536/123

(57) ABSTRACT

The present invention provides a method of recovering O-linked oligosaccharides from a macromolecule, the method comprising the steps: exposing the macromolecule to an alkaline agent to release O-linked olisaccharides from the macromolecule; separating the released oligosaccharide from the macromolecule; and recovering the oligosaccharide.

### TECHNICAL FIELD

The present invention relates to methods and systems for removing sugars from macromolecules, particularly the release of oligosaccharides from glycoproteins.

### BACKGROUND ART

Oligosaccharides on glycoproteins are usually found either linked to the hydroxyl group of serine or threonine (O-linked) or asparagine (N-linked). Similarly the glycans (polysaccharides) attached to proteoglycans are also often linked via the hydroxyl group on serine at threonine. So far, the method of choice for releasing of O-linked oligosaccharides from glycoproteins and mucoproteins has been the chemistry of p-elimination in dilute alkali [Carubelli et al., 1965]. The glycans are eliminated by incubation with dilute alkali, resulting in the release of a reducing glycan and the formation of an unsaturated amino acid (FIG. 1a). Reducing sugars, however, are unstable in alkali and undergo further β-elimination, known as peeling [Whistler and BeMiller, 1958; Lloyd et al., 1968], with subsequent rearrangement of the terminal residues to saccharinic acids [Stanek et al., 1963] (FIG. 1b). To prevent this, 0.8-1 M sodium borohydride is normally added [Carlson, 1968], to convert the reducing O-glycans to oligosaccharide alditols (FIG. 2a). Oligosaccharide alditols are stable to the action of alkali because they do not contain an aldehyde group.

A significant disadvantage of this method is that the resulting glycan alditols are unsuitable for further chemical derivatisation, which severely limits the possibilities for improving their detectability by the inclusion of a chromophore or fluorophore, for example. The addition of a radiolabel to the oligosaccharide alditols by using tritium-labelled borohydride is inherently inefficient because of the high molarity of reducing agent required to prevent peeling, and a large amount of ³H₂ gas is produced [Amano and Kobata, 1989].

A further disadvantage of reductive β-elimination is that it does not permit O- and N-linked glycans to be distinguished. Initially, it was believed that the N-glycosidic linkage was relatively stable to alkali [Neuberger et al., 1972] and was only hydrolysed using relatively harsh conditions such as 1 M sodium hydroxide and 1 M sodium borohydride at 100° C. for 4-6 hours [Lee and Scocca, 1972]. Rasilo and Renkonen [1981], however, found that mild alkaline sodium borohydride treatment was capable of releasing the N-linked glycans in the form of oligosaccharide-alditols. Ogata and Lloyd [1982] showed that N-linked glycans are released initially as glycopeptides, which are then mostly (60 percent) hydrolysed to oligosaccharides. It was subsequently shown that the presence of the borohydride was responsible for the release of the N-linked glycans, with the majority being recovered as glyco-asparagines [Argade et al., 1989]. Likhosherstov et al. [1990], proposed the inclusion of cadmium acetate to inhibit the reductive cleavage of N-glycosidic (and peptide) bonds and permit selective release of O-glycans. This method has not been widely accepted, possibly because ethylenediamine-tetra-acetic acid (EDTA) must be added to prevent the formation of solid cadmium hydroxide (Cd(OH)₂). The resulting cadmium-EDTA complex interferes with the separation and detection of the glycan alditols.

In 1993, Patel et al. described a mild hydrazinolysis method for the release and recovery of both O- and N-linked glycans, and yet milder conditions for the selective release and recovery of the O-linked glycans. The release of N-linked glycans required heating in anhydrous hydrazine at 95° C. or above, while the removal of the O-linked glycans can be achieved at 60° C. The difference resides in the mechanisms involved and there can be overlap of the two reactions which results in non-selective release of both types of glycans. N-linked glycans are removed by hydrazinolysis of the amide linkages of asparagine, while removal of the O-linked species probably involves a β-elimination process, promoted by the basicity of the hydrazine.

A result of using hydrazine is that, as the sugars are released, they are converted to the hydrazones and protected from peeling under the basic conditions. The glycan hydrazones must then be converted back to the reducing glycans by treatment with copper acetate [Patel et al., 1993; Patel and Parekh, 1994], or mild acid [Williams, 1983] for further derivatisation. This method has not been accepted as a routine way of removing the glycans from mucins or other glyco-molecules. The reasons for this have not been well documented, but the stability of the mucin-type glycans, especially the 1-3 linkage against peeling in hydrazine, the insolubility of mucins in anhydrous hydrazine and the toxicity, and flammability of hydrazine may be some of the reasons. Some peeling of mucin-type O-linked glycans consisting of Gal(β1-3)GalNAc, has been observed when immunoglobulin alpha (IgA) from human serum was treated using the conditions optimised for the release of O-linked glycans [Mattu et al., 1998].

Another major disadvantage of hydrazinolysis is the loss of information about the types of sialic acids originally present in the glycoprotein, as the acetyl and glycolyl groups attached to these monosaccharide residues are removed by hydrazine. These differences may be very important, as the presence of N-glycolylneurarninic acid may be characteristic of mucins associated with cancer [Devine et al., 1991; Devine and McKenzie, 1992; Hanisch et al., 1996].

Non-reductive release of O-linked oligosaccharides as glycan hydrazones using the mildly alkaline 0.2 M triethylamine in 50% aqueous hydrazine has been described by Cooper et al (1994). This method has similar limitations as that described for hydrazinolysis and has not proved to be successful for removal of the oligosaccharides from the highly glycosylated mucins. Similarly, the non-reductive release method described by Chai et al, (1997) using 70% w/v aqueous ethylamine requires high temperature to remove the oligosaccharide from porcine gastric mucin and results in extensive peeling and low yields relative to reductive alkaline hydrolysis.

The present inventors have now developed a new means of obtaining sugars from macromolecules containing sugars.

### SUMMARY OF THE INVENTION

Accordingly, in a first aspect the invention provides a method of recovering O-linked oligosaccharides from a macromolecule, the method comprising the following steps:

(i) exposing the macromolecule to an alkaline agent to release O-linked oligosaccharides from the macromolecule;

(ii) separating the released oligosaccharide from the macromolecule;

(iii) recovering the oligosaccharide.

In a second aspect, the invention provides a method of recovering O-linked oligosaccharides from a macromolecule the method comprising the following steps:

(i) binding the macromolecule to a support;

(ii) contacting the solid support from step (i) with a stream of an alkali agent to release O-linked oligosaccharides into the stream of alkali agent;

(iii) neutralising the alkali agent in the stream; and

(iv) recovering the oligosaccharide.

In a third aspect, the invention provides a system for recovering O-linked oligosaccharides from a macromolecule, the system comprising:

(i) a solid support for immobilising a macromolecule;

(ii) means for providing an alkaline agent to the solid support;

(iii) means for removing the alkaline agent from the solid support;

(iv) means for neutralising the alkaline agent subsequent to its removal from the solid support; and

(v) means for collecting the oligosaccharides.

### BRIEF DESCRIPTION OF FIGURES

FIG. 1: Mechanism of alkaline β-elimination for the removal of O-linked glycans from glycoproteins.

FIG. 2: Schematic of a) chemistry of β-elimination and b) chemistry of “peeling” reaction.

FIG. 3: Comparison of chemistry of a) reductive and b) non-reductive β-elimination.

FIG. 4: Diagram of process of non-reductive β-elimination using a system according to the present invention.

FIG. 5: Electrospray mass spectrum (ES-MS) of a) non-reduced oligosaccharides released from bovine submaxillary mucin by the system shown in FIG. 3, compared with b) reduced oligosaccharides released by reductive β-elimination.

FIG. 6: ES-MS of a) non-reduced oligosaccharides released from porcine gastric mucin by the system shown in FIG. 3, collected and then reduced, compared with b) reduced oligosaccharides released by reductive β-elimination.

FIG. 7: Table of masses obtained by ES-MS of non-reduced oligosaccharides released from porcine gastric mucin by the system shown in FIG. 3, collected and then reduced compared with the masses of reduced oligosaccharides released by reductive β-elimination.

FIG. 8: Time course of elimination of reducing oligosaccharides from a) bovine submaxillary mucin and b) porcine gastric mucin.

FIG. 9: ES-MS of non-reduced oligosaccharides from bovine fetuin.

FIG. 10: ES-MS of non-reduced oligosaccharides released from porcine gastric mucin by the system shown in FIG. 4, collected and then reacted with hydroxylamine to tag the available reducing end with a functional group enabling positive ES-MS.

FIG. 11: Apparatus comprising a system for recovering O-linked oligosaccharides from a macromolecule.

FIG. 12: Solid support apparatus for immobilising a macromolecule, and thermal heating block.

FIG. 13: Solid support apparatus for immobilising a macromolecule, chromatography column, means for collecting oligosaccharides and thermal heating block.

FIG. 14: Chromotography column, and means for collecting oligosaccharides.

FIG. 15: Sectional view of chromatography column, and means for collecting oligosaccharides.

FIG. 16: Means for collecting oligosaccharides.

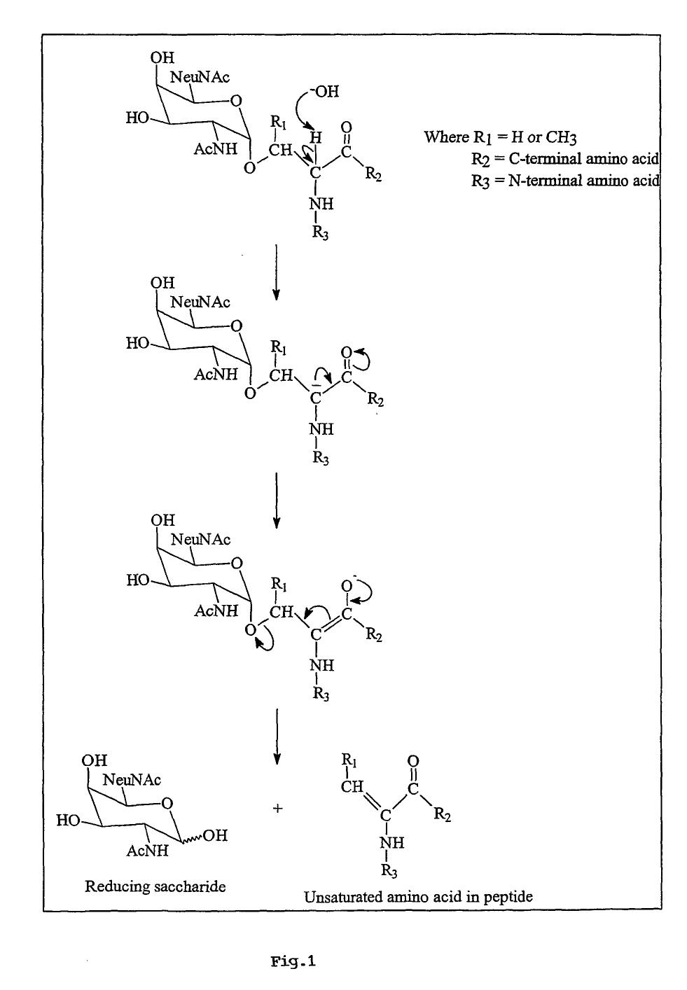

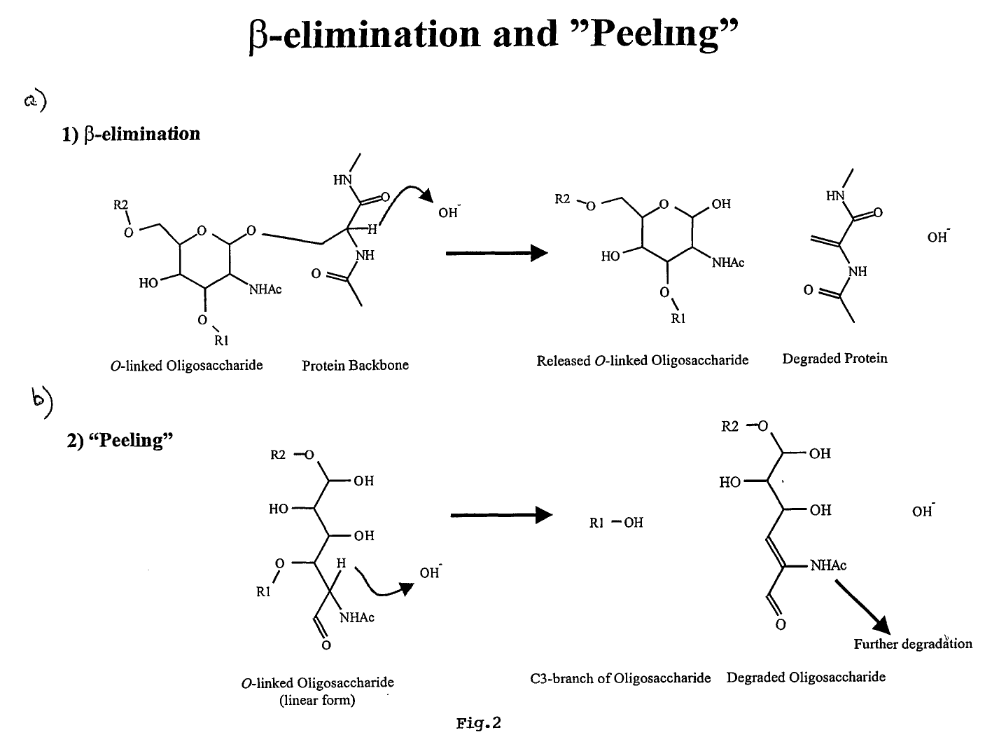

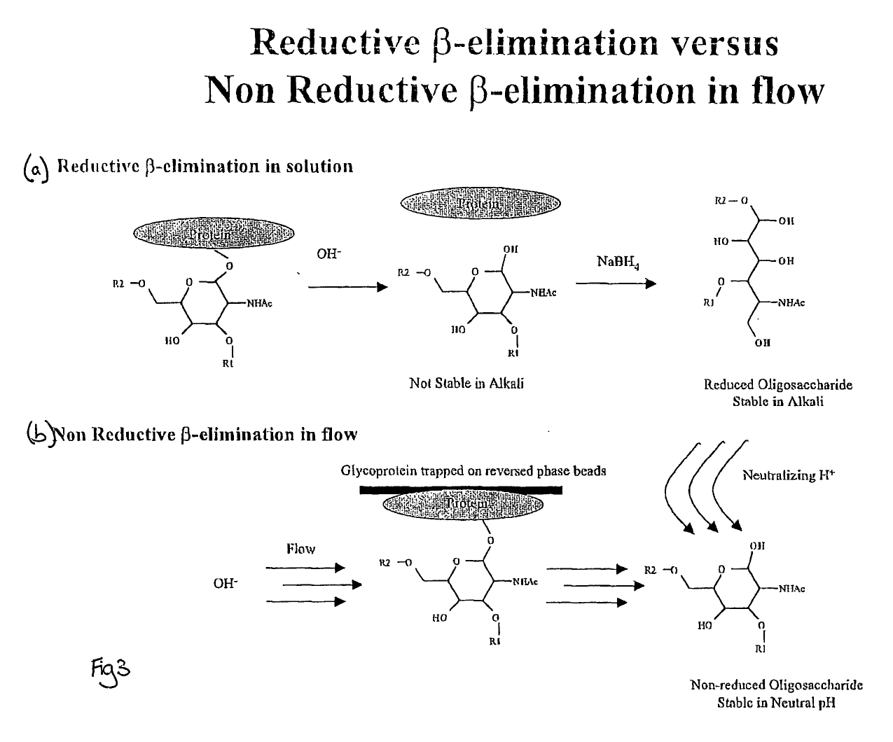

### DETAILED DESCRIPTION OF INVENTION

In a first aspect the invention provides a method of recovering O-linked oligosaccharides from a macromolecule, the method comprising the following steps:

(i) exposing the macromolecule to an alkaline agent to release O-linked oligosaccharides from the macromolecule;

(ii) separating the released oligosaccharide from the macromolecule;

(iii) recovering the oligosaccharide.

Preferably, the macromolecule is bound to a support.

Preferably, the released oligosaccharide is separated from the macromolecule in association with the alkaline agent and the alkaline agent is neutralised.

In one embodiment, the alkaline agent is neutralised by addition of acid or chromatography cation exchange media.

Preferably, the alkali agent is potassium hydroxide, sodium hydroxide or ammonium hydroxide.

Preferably, the concentration of alkali is 0.05 M-1.0 M. More preferably, the alkali is 0.05 M-0.5 M sodium hydroxide.

In one embodiment of the invention the macromolecule is exposed to the alkali agent at about 45° C. for about 10 hours to about 40 hours, preferably about 16 hours.

In a second aspect, the invention provides a method of recovering O-linked oligosaccharides from a macromolecule the method comprising the following steps:

(i) binding the macromolecule to a support;

(ii) contacting the solid support from step (i) with a stream of an alkali agent to release O-linked oligosaccharides into the stream of alkali agent;

(iii) neutralising the alkali agent in the stream; and

(iv) recovering the oligosaccharide.

Preferably, the support is a chromatographic material or a membrane or other porous hydrophobic material.

More preferably, the support is reverse phase chromatography beads.

In one embodiment step (iii) comprises passing the stream through a medium which neutralises the alkali agent. Preferably, the medium is chromatography cation exchange media.

In an alternate embodiment step (iii) comprises addition of an acid or chromatography cation exchange media to the stream. Preferably, the acid is hydrochloric acid.

In a preferred embodiment of the first and second aspects, the macromolecule is a glycoprotein.

In a third aspect, the invention provides a system for recovering O-linked oligosaccharides from a macromolecule, the system comprising:

(i) a solid support for immobilising a macromolecule;

(ii) means for providing an alkaline agent to the solid support;

(iii) means for removing the alkaline agent from the solid support;

(iv) means for neutralising the alkaline agent subsequent to its removal from the solid support; and

(d) means for collecting the oligosaccharides.

Preferably, the solid support is a column comprising reversed phase chromatography material capable of binding macromolecules.

Preferably, the means for providing the alkaline agent is a pump and the alkaline agent is an alkaline solution.

In one embodiment the means for neutralising the alkaline agent is a column packed with cation-exchange chromatography material.

In a second embodiment the means for neutralising the alkaline agent is an intersecting flow (stream) of acid.

Preferably, the means for collecting oligosaccharides is a column packed with graphitised carbon.

In one embodiment the carbon is porous graphitised carbon.

In a preferred embodiment the columns are placed in-line.

In a further preferred embodiment the columns are placed in-line and the column packed with porous graphitised carbon is connected to a mass spectrophotometer.

The present invention is particularly useful to obtain from glycoproteins O-linked oligosaccharides which have their reducing terminal monosaccharide still in its reducing configuration. This allows for further derivatisation of the reducing end of the oligosaccharide, thus enabling methods for increasing the detectability by spectroscopic methods either by the addition to the oligosaccharide of either a chromophore, fluorophase, or mass spectrometric ionisable tag.

The analysis of O-linked oligosaccharides attached to glycoproteins has been hampered by both the lack of an enzyme able to universally remove all O-linked oligosaccharides as well as by the lack of sensitivity of the analytical tools available for their analysis. Carbohydrates have little absorbance or fluorescence in either visible or ultra-violet light so the standard spectroscopic procedures are unable to be used. Similarly the use of mass spectrometric analysis is limited by the lack of readily ionisable groups contained in the oligosaccharides and the consequent low sensitivity of detection. Traditionally, in the analysis of glycans, the sensitivity of detection is increased by the covalent attachment to the oligosaccharide of a tag whose properties enhance the particular technique being used. The most reactive functional group on a glycan is the reducing terminus of the sugar. Labelling only this terminal moiety in the oligosaccharide does not alter its native structure and has the additional benefit of creating a tagged end of the structure which can be located easily.

Alkaline α-elimination is accepted as the most quantitative method for releasing the O-linked oligosaccharides from serine and threonine, but the active reducing terminus is peeled in alkali resulting in the degradation of the glycan structure. Traditionally, the best method for protecting the reducing terminus from this degradation is to form the reduced sugar which is stable in alkali. The reduced terminal monosaccharide however is no longer reactive and cannot be tagged with a group to increase the sensitivity of detection of the oligosaccharide.

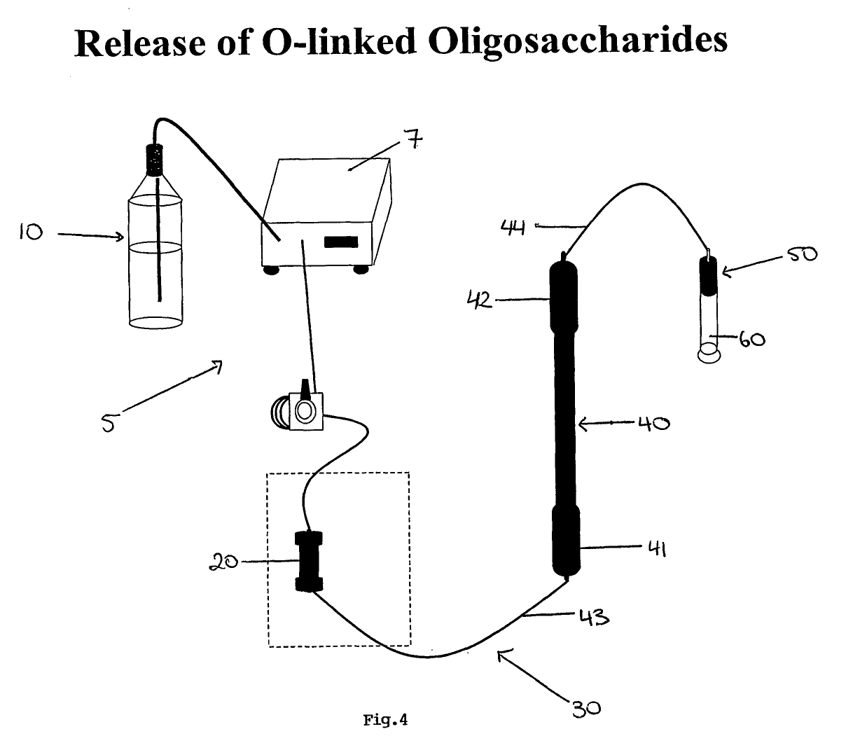

The particular value of a preferred system used for the methods of the present invention and illustrated schematically in FIG. 4 is in the production of released O-linked oligosaccharides in their reducing form which are able to be further reacted to increase the sensitivity of analysis of glycans. This process can be applied to all O-linked glycoproteins and is demonstrated to be successful even with the highly glycosylated mucin glycoproteins which are known to be difficult to analyse.

In order that the present invention may be more clearly understood preferred forms will be described with reference to the following figures.

As depicted in FIG. 4, a system for removing sugars from a macromolecule comprises a solid support 20 for immobilising a macromolecule, a means 5 for providing an alkaline agent; a means 30 for removing the alkaline agent from the solid support; a means 40 for neutralising the alkaline agent; and a means 50 for collecting oligosaccharides.

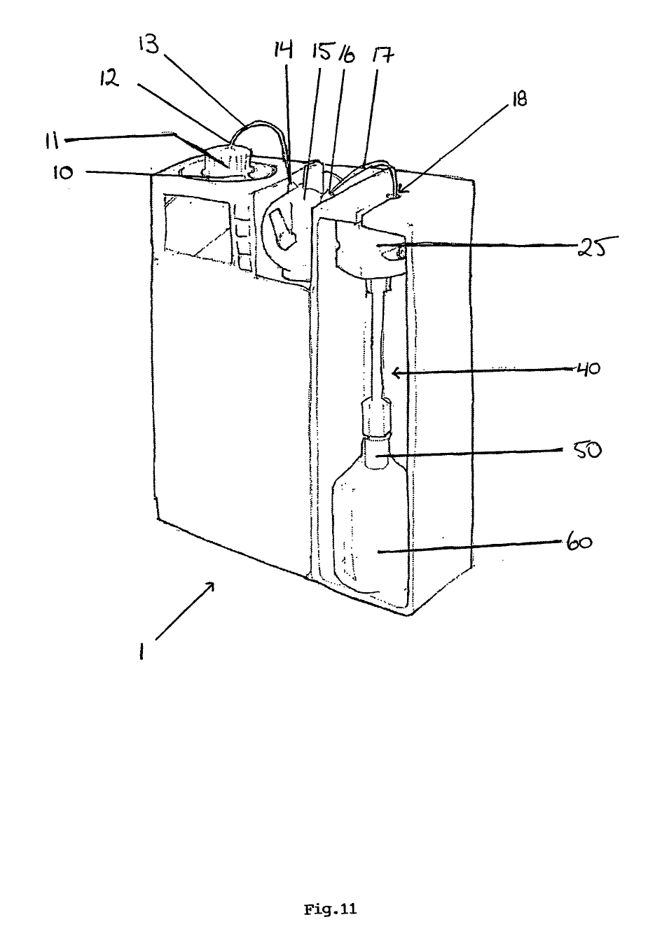

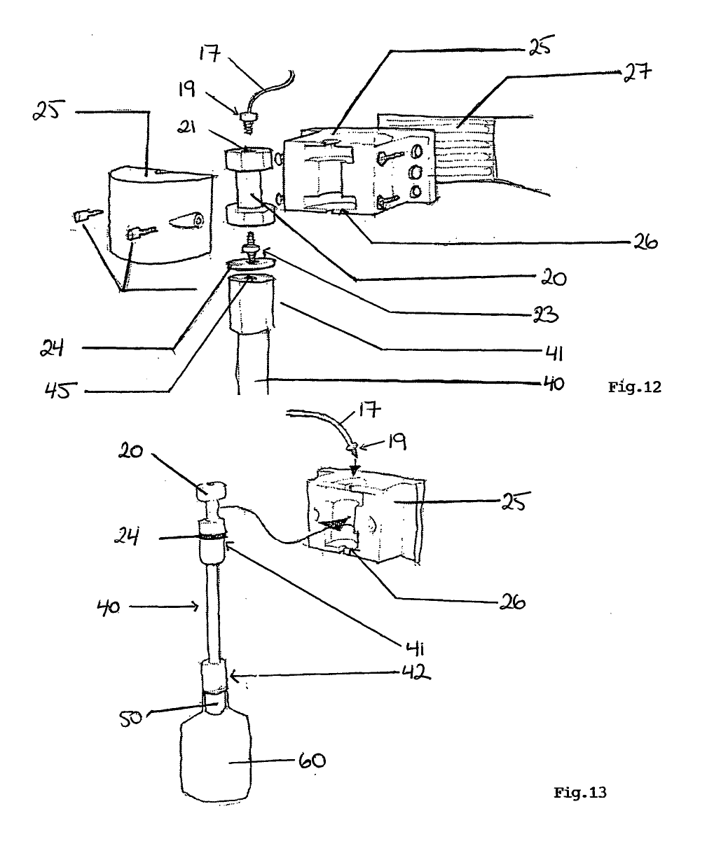

An apparatus 1 for a system for removing sugars from a macromolecule is depicted in more detail in FIGS. 11, 12 and 13.

The apparatus 1 comprises a reagent container 10 having a closure 11. The closure 11 has an outlet 12 that receives a proximal end of a flexible tube 13. The flexible tube 13 is received at its distal end by an inlet 14 of an injector 15.

The flexible tube 13 serves to provide fluid connection between the container 10 and the injector 15.

The means 5 for providing an alkaline agent further comprises a pump 7 that is housed within the apparatus 1.

A second flexible tube 17 further extends from the injector 15 at an outlet 16 through an orifice 18 and into sealing engagement with solid support 20.

A screw connector 19 is used to sealingly engage an aperture 21 on an upper surface of the solid support 20.

The solid support 20 is spool-shaped. The solid support 20 has the aperture 21 for receiving the alkaline agent and an outlet (not shown) for releasing the alkaline agent.

The solid support is packed with reverse phase beads, such as R2-reversed phase beads or alternatively may contain a membrane.

The solid support 20 is housed in an insulated heating block 25. The insulated heating block 25 can be machined aluminium. The insulated heating block 25 has a recess 26 configured to receive the solid support 20. The insulated heating block 25 further comprises a heating device 27. The heating device 27 can be a thermofilm.

The solid support 20 has an outlet on its lower surface (not shown) which sealingly engages a first end of a screw connector 23. At a second end the screw connector 23 connects to a means 40 for neutralising the alkaline reagent.

A circular insulating pad 24 having a circular orifice to receive the screw connector 23 is positioned between the solid support 20 and the means 40 for neutralising the alkaline reagent.

As depicted in FIG. 4, the means 40 for neutralising the alkaline reagent has a first end 41 and a second end 42. The first end 41 is connected by a tube 43 to the solid support 20.

Alternatively and as depicted in FIGS. 11, 12 and 13, the first end 41 of the means 40 for neutralising the alkaline reagent can be directly engaged with the solid support 20. In this case, the first end 41 has an orifice 45 to receive the screw connector 23.

The means 40 for neutralising the alkaline agent can be a column packed with cation-exchange chromatography material.

As depicted in FIG. 4, the second end 42 of the means 40 for neutralising the alkaline reagent is connected by a tube 44 to a means 50 for collecting oligosaccharides.

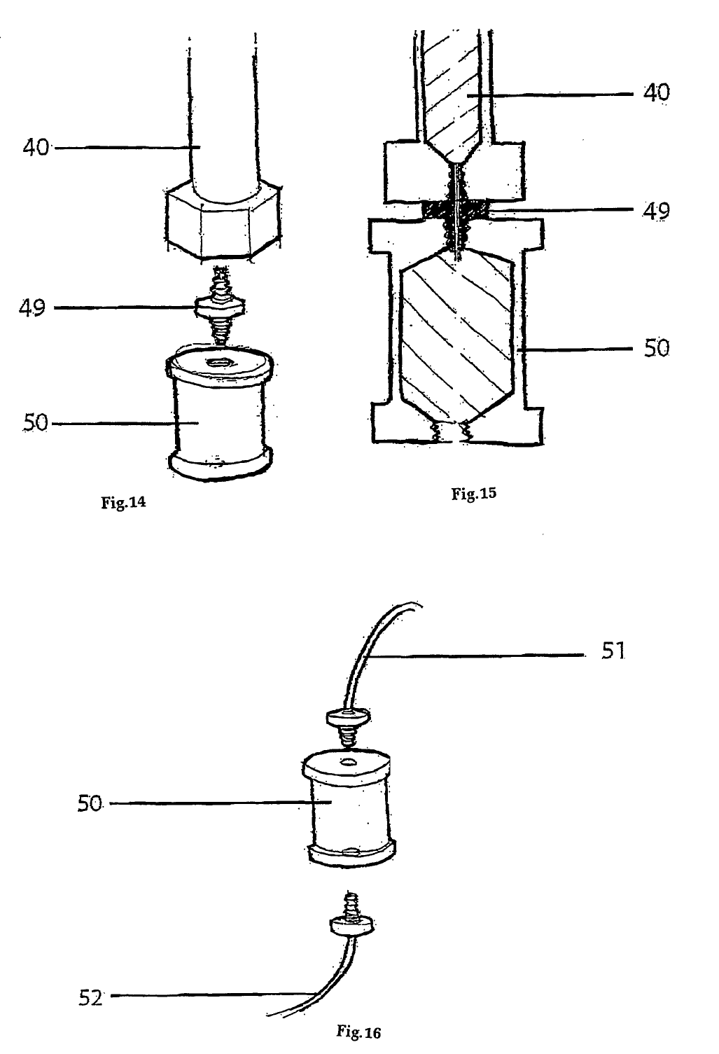

Alternatively and as depicted in FIGS. 11, 12, and 13, the means 40 for neutralising is directly engaged with a means 50 for collecting oligosaccharides. As depicted in FIGS. 14, 15 and 16, the means 50 for collecting oligosaccharides is detachably engaged with the means 40 for neutralising the alkaline agent by a screw and washer connector 49.

The means 50 for collecting oligosaccharides can be a column or cartridge packed with graphitised carbon. The graphitised carbon can be porous graphitised carbon.

In a most preferred embodiment and as depicted in FIGS. 11, 12 and 13, the solid support 20 for immobilising a macromolecule, means 40 for neutralising the alkaline agent; and means 50 for collecting oligosaccharides are longitudinally aligned.

As depicted in FIG. 16, the means 50 for collecting oligosaccharides can be detached from the means 40 for neutralising the alkaline agent and connected to a tube 51 which provides an alternate fluid connection.

As depicted in FIGS. 11, 12 and 13 waste product can be collected in a waste container 60.

In another embodiment as depicted in FIG. 16, the means 50 for collecting oligosaccharides can be detached from the waste container 60. The means 50 for collecting oligosaccharides can be connected to a tube 52.

The means 50 for collecting oligosaccharides can be connected with a mass spectrophotometer by the tube 52.

In order that the nature of the present invention may be better understood preferred uses will be described with reference to the following Examples.

### EXAMPLE 1

Release of Oligosaccharides from Bovine Submaxillary Mucin

Mucins consist of highly glycosylated regions of serine and threonine amino acids. The glycosylation of these regions is varied and the structures of these oligosaccharides are usually analysed after their release from the protein.

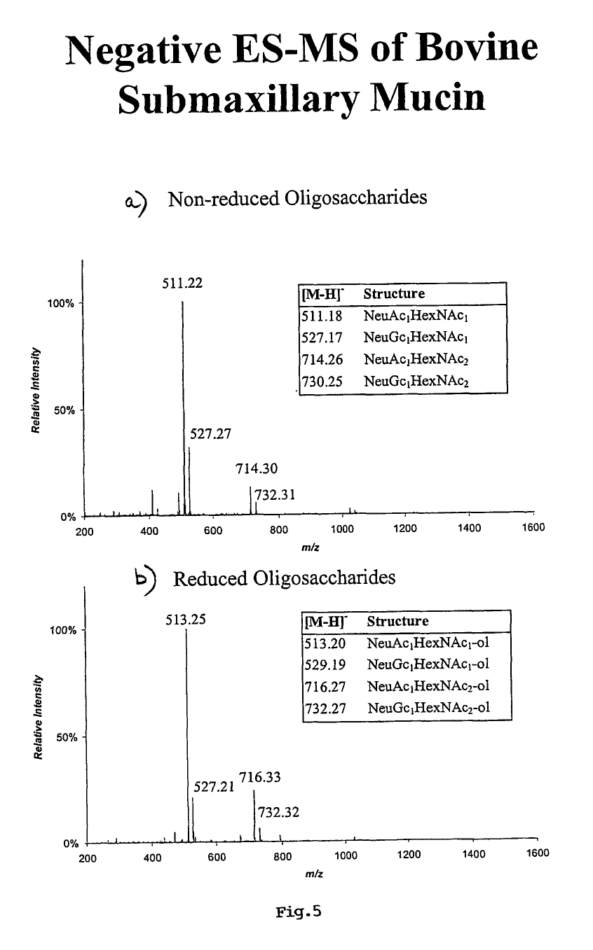

Reversed phase Poros™ R2 (polystyrene beads coated with divinyl benzene, PE Biosciences) (10 mg) were added to a solution of 1.0 mg of bovine submaxillary mucin (BSM, Sigma) in 1 ml 9:1H₂O:ACN. The glycoprotein-coated beads were packed into a (A) cartridge and a solution of 0.05 M potassium hydroxide was pumped through at a flow rate of 0.1 ml/min for 16 hrs at 45° C. The eluent from the reversed phase beads was passed immediately through an in-line cation exchange column (AG50W-X8 4.6 mm i.d.×27 cm, 7.6 meq capacity) which was placed in-line with a conditioned (washed with several column volumes of 80% acetonitrile:0.1% TFA, followed by re-equilibration with water) graphitised carbon cartridge (300 mg). The retained sugars recovered by elution with 2 ml of a pH 9.0 ammonium formate buffer (50 mM) with 25% acetonitrile were analysed by electrospray ionisation time of flight mass spectrometry (ESI-TOF) (FIG. 5a).

The masses of the recovered glycans were compared with the masses of the reduced glycans recovered by conventional reductive β-elimination in which the same amount of BSM was incubated in 0.05M potassium hydroxide, 1.0 M sodium borohydride for 16 hrs at 45° C. This sample was also desalted on a graphitised carbon cartridge before analysis by ESI-TOF (FIG. 5b). The same oligosaccharide masses (taking into account the addition of 2 Da upon reduction) were obtained by both methods. The glycosylation pattern with respect to the relative intensities of the molecular ions were also preserved between the two methods of release. The oligosaccharides from bovine submaxillary mucin have been described previously, and the dominating oligosaccharides are the NeuAc/NeuGcα2-6GalNAc and GlcNAcβ1-3(NeuAc/NeuGcα2-6)GalNAc. The similar relative amount of recovery of the latter species in the non reduced sample (FIG. 5) and the reduced sample demonstrate that the level of peeling is negligible.

### EXAMPLE 2

Release of Oligosaccharides from Porcine Gastric Mucins (PGM)

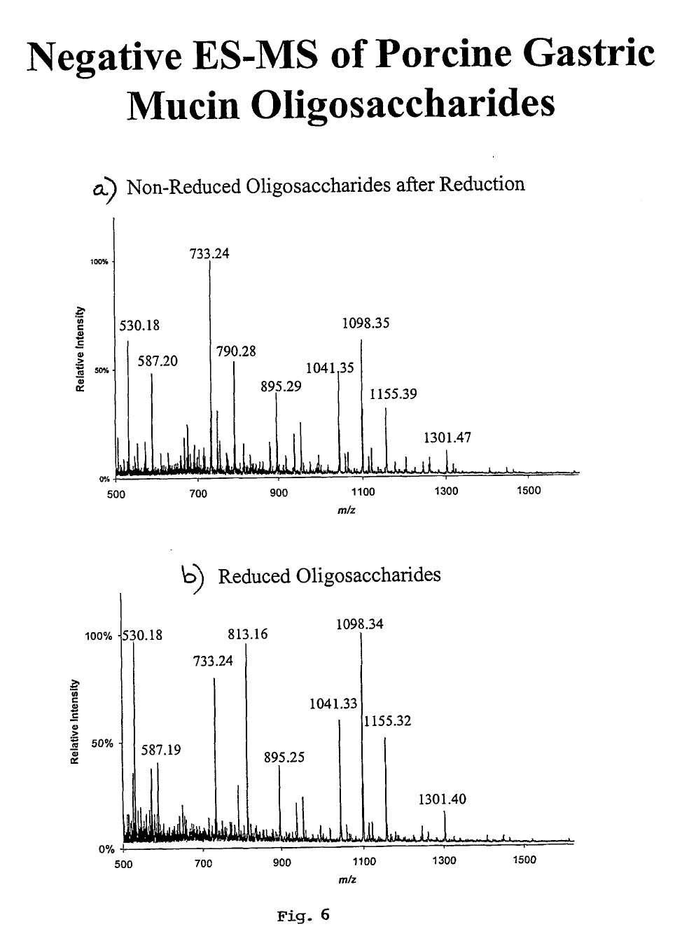

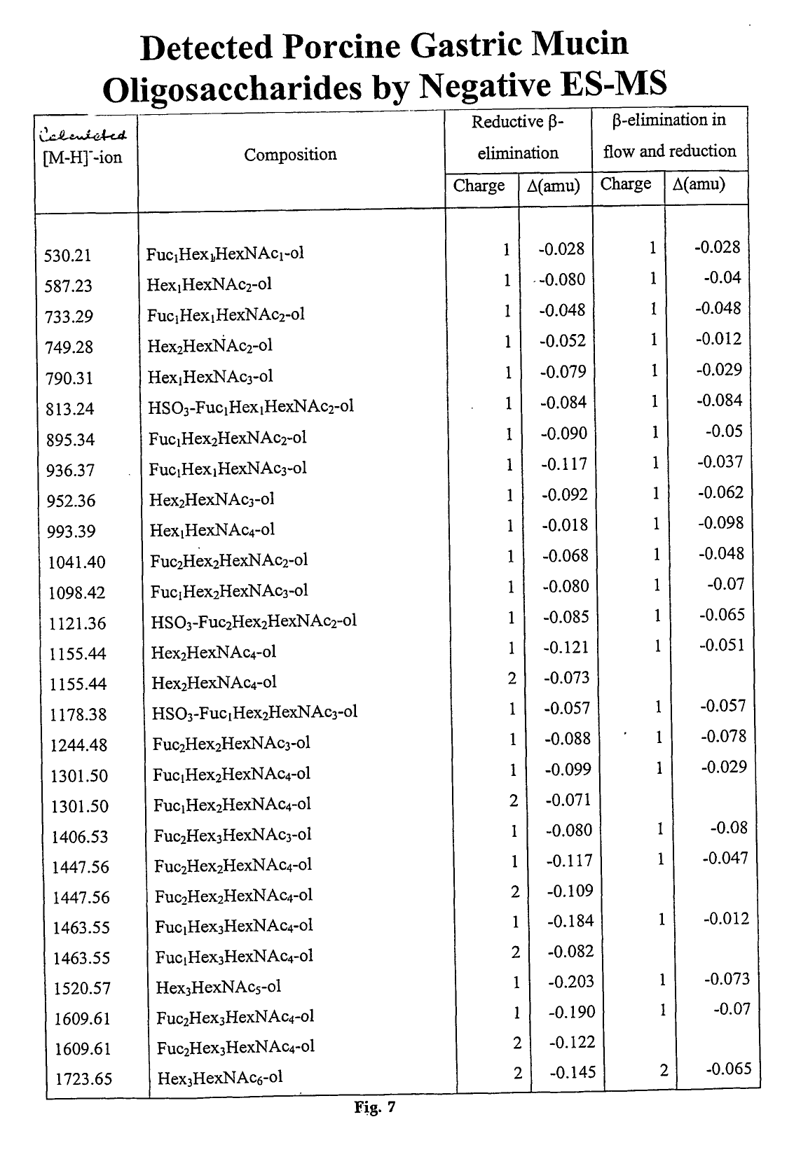

Porcine gastric mucins are very heterogenous glycosylated with mainly large neutral oligosaccharide species (Karlsson et al, 1997) and sulphated species. The present inventors subjected 1.0 mg of porcine gastric mucin (Sigma) to the same treatment as bovine submaxillary mucins. The potassium hydroxide flow was neutralised with a flow of 0.1 ml/min 0.05 M HCl and collected online on a small Hypercarb (porous graphitised carbon) (Shandon, UK) guard column (10×4 mm). The oligosaccharides were eluted with the described gradient for LC-MS analysis for bovine submaxillary mucin oligosaccharides and the porcine gastric oligosaccharides were collected. Half of the sample was reduced in 0.05 M potassium hydroxide, 1.0 M sodium borohydride, and analysed with LC-MS (FIG. 6a) as described above for bovine submaxillary mucin oligosaccharides. The sample was compared with porcine gastric mucin oligosaccharides released from 1.0 mg of mucin by 0.05 M potassium hydroxide in presence of 1.0 M sodium borohydride.(FIG. 6b). The detected oligosaccharide masses are summarised in Table 1 (FIG. 7).

### EXAMPLE 3

Time Course for the β-Elimination Reaction in Flow

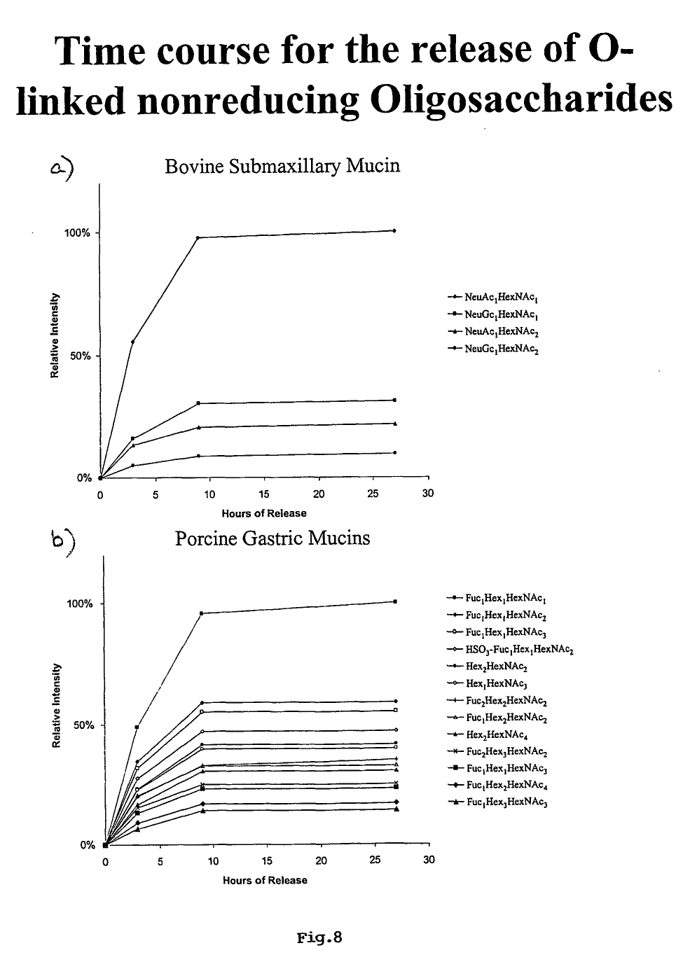

Porcine gastric mucins and bovine submaxillary mucins (1.0 mg each) were immobilised on R2-beads and each mucin was subjected individually to β-elimination reaction in flow, neutralising the alkali with an in-line H+-exchange column (AG50W-X8 4.6 mm i.d.×27 cm, 7.6 meq capacity). The oligosaccharides were trapped on graphitised carbon cartridges (300 mg) that was changed after 3, 6 and 27 hours. Samples were eluted as described and subjected to LC-MS as described above, detecting ions in negative mode. The response for the mono-isotopic ion for each oligosaccharide composition [M-H]⁻-ion was recorded and the reaction was considered to be complete after 27 hours (FIGS. 8a and 8b), thus setting the sum of the recorded responses for each time point and oligosaccharide species to 100% at 27 hours.

### EXAMPLE 4

Release of Oligosaccharides from Bovine Fetuin

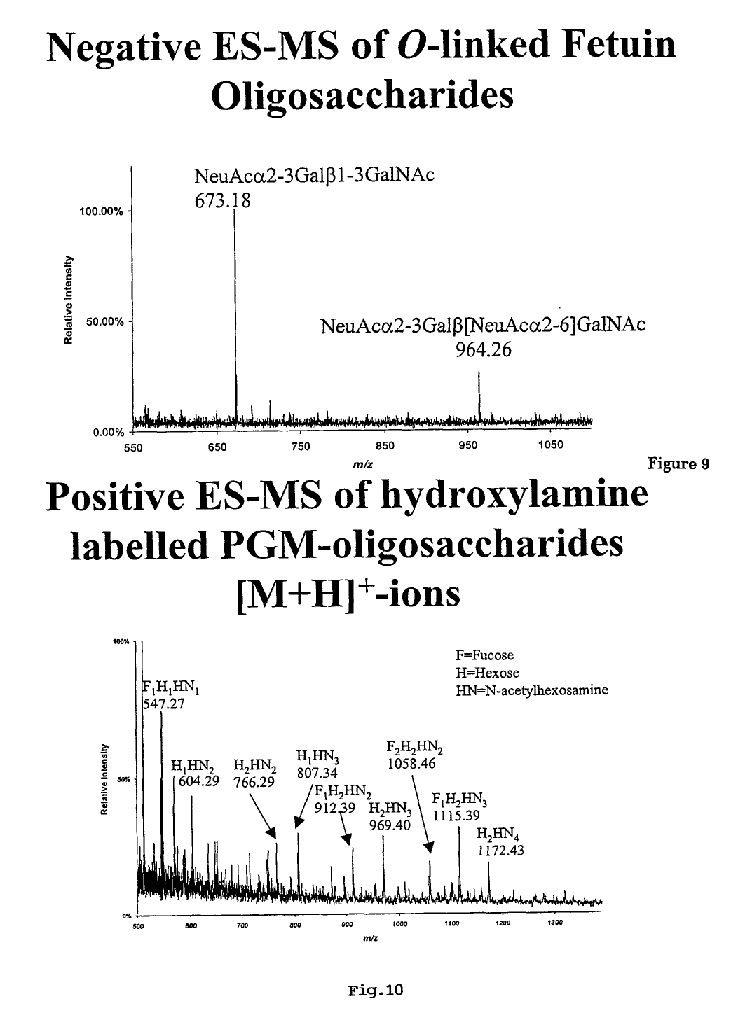

Bovine fetuin has three sites of O-glycosylation and three sites of N-glycosylation. N-linked glycans are usually removed enzymically but there is no suitable enzyme for the release of the O-linked glycans. The O-linked oligosaccharides from fetuin has been described and are dominated by structures containing sialic acid on the C-3 branch of the protein linking GalNAc. Oligosaccharides were recovered by coating fetuin onto R2-beads as described above for Bovine subaxillary mucin with the on-line cation exchange neutralising column and a porous graphitised carbon cartridge (10×4 mm). The eluate was introduced directly on-line to the mass spectrometer with a flow of 10 μl/min. Negative molecular ions ([M-H]⁻-ions) were detected (FIG. 9) with the composition of the dominating oligosaccharides described from bovine fetuin. The linkage configuration and sequence in the FIG. 9 are assigned from the references illustrating that oligosaccharides with extension on the C-3 of the proximal GalNAc can be recovered in high yields. FIG. 9 also illustrates that O-linked oligosaccharides also can be recovered not only from mucins but also from less glycosylated glycoproteins.

### EXAMPLE 5

Reaction of Reducing Terminus to Enhance Sensitivity of Detection

Porcine gastric mucin-oligosaccharides were prepared in the process from 1.0 mg of porcine gastric mucin as described for above. One fourth of the sample was derivatised in 450 μl of 67 mM hydroxylamine hydrochloride (Sigma) and 0.87 M sodiumcyanoborohydride at 50° C. for 16 h, and 100 μl was subjected to positive LC-MS. Oligosaccharides was eluted from a small Hypercarb guard column (10×4 mm), with a gradient from 0-90% acetonitrile under 5 min with constant 0.2% formic acid throughout the LC-MS run. FIG. 10 illustrates that recovered non-reduced oligosaccharides could be derivatised in order to alter the mass spectrometric properties and increase the sensitivity of detection.

Any discussion of documents, acts, materials, devices, articles or the like which has been included in the present specification is solely for the purpose of providing a context for the present invention. It is not to be taken as an admission that any or all of these matters form part of the prior art base or were common general knowledge in Australia before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

### REFERENCES

Amano J. and Kobata A. (1989) Quantitative conversion of mucin-type sugar chains to radioactive oligosaccharides. Methods Enzymol. 179, 261-270.

Argade S. P., Davies Jr G. D., Van Halbeek H., and Alhadeef J. A. (1989) The effect of alkaline borohydride treatment on N-linked carbohydrates of glycoproteins. Glycoconj. J. 6, 45-56.

Bertolini M. and Pigman W. (1967) Action of alkali on bovine and ovine submaxillary mucins. J. Biol. Chem. 242, 3776-3781.

Carlson D. M. (1966) Oligosaccharides isolated from pig submaxillary mucin. J. Biol. Chem. 241, 2984-2986.

Carubelli R., Bhavanandan V. P., and Gottschalk A. (1965) Studies on glycoproteins. XI. The O-glycosidic linkage of N-acetylgalactosamine to seryl and threonyl residues in ovine submaxillary gland glycoprotein. Biochim. Biophys. Acta 101, 67-82.

Chai, W., Feizi, T., Yuen, C. T. Lawson, Mass. (1997) Nonreductive release of O-linked oligosaccharides from mucin glycoproteins for structure/function assignments as neoglycolipids: application in the detection of novel ligands for E-selectin. Glycobiology 7, 861-872.

Cooper C. A., Packer N. H., and Redmond J. W. (1994) The elimination of O-linked glycans from glycoproteins under non-reducing conditions. Glycoconj. J. 11, 163-167.

Devine P. and McKenzie I. (1992) Mucins: structure, function, and associations with malignancy. BioEssays 14, 619-625.

Devine P. L., Clark B. A., Birrell G. W., Layton G. T., Ward B. G., Alewood P. F., and Mckenzie I. F. C. (1991) The breast tumor-associated epitope defined by monoclonal antibody 3E1.2 is an O-linked mucin carbohydrate containing N-glycolylneuraminic acid. Cancer Research 51, 5826-5836.

Hanisch F. G., Stadie T. R., Deutzmann F., and Peter-Katalinic J. (1996) MUC1 glycoforms in breast cancer-cell line T47D as a model for carcinoma-associated alterations of O-glycosylation. Eur. J. Biochem. 236, 318-327.

Karlsson, N. G., Nordman, H., Karlsson, H., Carlstedt, I and Hansson, G. C. (1997) Glycosylation differences between pig gastric mucin populations: a comparative study of the neutral oligosaccharides using mass spectrometry. Biochem. J. 326, 911-917.

Lee Y. C. and Scocca J. R. (1972) A common structural unit in asparagine-oligosaccharides of several glycoproteins from different sources. J. Biol. Chem. 247, 5753-5758.

Likhosherstov L. M., Novikova O. S., Dereviskaya V. A., and Kochetkov N. K. (1990) A selective method for sequential splitting of O- and N-linked glycans from N,O-glycoproteins. Carbohydr. Res. 199, 67-76.

Lloyd K. O. and Savage A. (1991) High performance anion exchange chromatography of reduced oligosaccharides from sialomucins. Glycoconj. J. 8, 493-498.

Mattu T. S., Pleass R. J., Willis A. C., Kilian M., Wormald M. R., Lellouch A. C., Rudd P. M., Woof J. M., and Dwek R. A. (1998) The glycosylation and structure of human serum IgA1, Fab and Fc regions and the role of N-glycosylation on Fc-alpha receptor interactions. J. Biol. Chem. 273, 2260-2272.

Neuberger A., Gottschalk A., Marshall R. D., and Spiro R. G. (1972) Carbohydrate-peptide linkages in glycoproteins and methods for their elucidation, in Glycoproteins: their composition, structure and function Vol. 2 (Gottschalk A., ed), pp. 450-490. Elsevier, Amsterdam.

Ogata Shun-I. and Lloyd K. O. (1982) Mild alkaline borohydride treatment of glycoproteins—a method for liberating both N- and O-linked carbohydrate chains. Anal. Biochem. 119, 351-359.

Patel T. P. and Parekh R. B. (1994) Release of oligosaccharides from glycoproteins by hydrazinolysis. Methods Enzymol. 230, 57-66.

Patel T., Bruce J., Merry A., Bigge C., Wormald M., Jaques A., and Parekh R. (1993) Use of hydrazine to release in intact and unreduced form both N- and O-linked oligosaccharides from glycoproteins. Biochemistry 32, 679-693.

Rasilo Maija-L. and Renkonen O. (1981) Mild alkaline borohydride treatment liberates N-acetylglucosamine-linked oligosaccharide chains of glycoproteins. FEBS Lett. 135, 38-42.

Stanek J., Cerny M., Kocourek J., and Pacak J. (1963) The Monosaccharides. Academic Press; and Publishing House of The Czechoslovak Academy of Sciences, New York/London/Prague.

Whistler R. J. and BeMiller J. N. (1958) Alkaline degradation of polysaccharides. Adv. Carbohydr. Chem. Biochem. 13, 289-329.

Williams J. M. (1983) Tautomerism of saccharide hydrazones in solution and their reaction with nitrous acid. Carbohydr. Res. 117, 89-94.

1. A method of recovering O-linked oligosaccharides from a macromolecule, the method comprising the following steps:
(i) exposing the macromolecule to an alkaline agent to release O-linked oligosaccharides from the macromolecule;
(ii) separating the released oligosaccharide from the macromolecule;
(iii) recovering the oligosaccharide.

2. The method according to claim 1, wherein the macromolecule is bound to a support.

3. The method according to claim 1 or claim 2 wherein the released oligosaccharide is separated from the macromolecule in association with the alkaline agent and the alkaline agent is neutralised.

4. The method according to claim 3 wherein the alkaline agent is neutralised by addition of acid or chromatography cation exchange media.

5. The method according to any one of claims 1 to 4 wherein the alkali agent is potassium hydroxide, sodium hydroxide or ammonium hydroxide.

6. The method according to any one of claims 1 to 5 wherein the concentration of alkali is 0.05 M-1.0 M.

7. The method according to any one of claims 1 to 6 wherein the alkali is 0.05 M-0.5 M sodium hydroxide.

8. The method according to any one of claims 1 to 7 wherein the macromolecule is exposed to the alkali agent at about 45° C. for about 10 hours to about 40 hours preferably about 16 hours.

9. A method of recovering O-linked oligosaccharides from a macromolecule the method comprising the following steps:
(i) binding the macromolecule to a support;
(ii) contacting the solid support from step (i) with a stream of an alkali agent to release O-linked oligosaccharides into the stream of alkali agent;
(iii) neutralising the alkali agent in the stream; and
(iv) recovering the oligosaccharide.

10. The method according to claim 9 wherein the support is a chromatographic material or a membrane.

11. The method according to claim 9 wherein the support is reverse phase chromatography beads.

12. The method according to any one of claims 9 to 11 wherein step (iii) comprises passing the stream through a medium which neutralises the alkali agent.

13. The method according to claim 12 wherein the medium is chromatography cation exchange media.

14. The method according to any one of claims 9 to 11 wherein step (iii) comprises addition of an acid or chromatography cation exchange media to the stream.

15. The method according to claim 14 wherein the acid is hydrochloric acid.

16. The method according to any one of claims 1 to 15 wherein the macromolecule is a glycoprotein.

17. A system for recovering O-linked oligosaccharides from a macromolecule, the system comprising:
(i) a solid support for immobilising a macromolecule;
(ii) means for providing an alkaline agent in the absence of a reducing agent, to the solid support;
(iii) means for removing the alkaline agent from the solid support;
(iv) means for neutralising the alkaline agent subsequent to its removal from the solid support; and
(d) means for collecting the oligosaccharides.

18. The system according to claim 17 wherein the solid support is a column comprising reversed phase chromatography material capable of binding macromolecules.

19. The system according to claim 17 or 18 wherein the means for providing the alkaline agent is a pump and the alkaline agent is an alkaline solution.

20. The system according to any one of claims 17 to 19 wherein the means for neutralising the alkaline agent is a column packed with cation-exchange chromatography material.

21. The system according to any one of claims 17 to 20 wherein the means for collecting oligosaccharides is a column packed with graphitised carbon.

22. The system according to any one of claims 17 to 21 wherein the columns are placed in-line.
